(19) United States
(12) Patent Application Publication
(10) Pub. No.: US 2016/0372787 A1
(43) Pub. Date: Dec. 22, 2016

(54) GEL POLYMER ELECTROLYTE AND SECONDARY BATTERY COMPRISING THE SAME

(71) Applicant: KOREA INSTITUTE OF SCIENCE AND TECHNOLOGY, Seoul (KR)

(72) Inventors: Kyung Yoon CHUNG, Seoul (KR); Hun-Gi JUNG, Seoul (KR); Won Young CHANG, Seoul (KR); Byung Won CHO, Seoul (KR); Wonchang CHOI, Seoul (KR); Si Hyoung OH, Seoul (KR); Yoon-Sung LEE, Seoul (KR); Susanto DIEKY, Seoul (KR); Dong-Won KIM, Seoul (KR); Won-Kyung SHIN, Seoul (KR)

(21) Appl. No.: 14/951,973

(22) Filed: Nov. 25, 2015

(30) Foreign Application Priority Data
Jun. 19, 2015 (KR) 10-2015-0087382

(51) Int. Cl. H01M 10/0565

(52) U.S. Cl. CPC H01M 10/0565; H01M 2220/10; H01M 2220/20; H01M 2220/30

(57) ABSTRACT

Provided are a gel polymer electrolyte and a secondary battery including the same. More particularly, the gel polymer electrolyte includes a sodium cation-containing polymer from which sodium cations can be dissociated, and thus provides improved ion conductivity of sodium cations, thereby improving the electrochemical properties of a secondary battery.

### CROSS-REFERENCE TO RELATED APPLICATIONS

This application claims priority under 35 U.S.C. §119 to Korean Patent Application No. 10-2015-0087382 filed on Jun. 19, 2015 in the Korean Intellectual Property Office, the disclosure of which is incorporated herein by reference in its entirety.

### TECHNICAL FIELD

The following disclosure relates to a gel polymer electrolyte applicable to a secondary battery and a secondary battery including the same.

### BACKGROUND

Recently, lithium secondary batteries are commercially available and used as energy storage devices for large-capacity cars and electric power storage systems as well as for compact electronic instruments. Under these circumstances, there has been an increasing demand and need for study of novel next-generation batteries in order to solve the problems including the high cost of lithium and concern for international situation caused by resource localization of lithium absolutely essential for lithium secondary batteries. Particularly, sodium ion secondary batteries based on sodium have been studied actively in Japan and Korea, poor countries in terms of resources, or the like, since sodium is a resource easily available everywhere on the earth and has easiness of securement, and sodium ion secondary batteries have an advantage of electrochemical structure in that they show charge/discharge behavior similar to lithium secondary batteries.

A sodium ion secondary battery has electrodes including an anode and cathode capable of sodium ion intercalation/deintercalation, a separator for preventing an internal short physically, and an organic liquid electrolyte through which sodium cations are transferred. Among those, it is known that the organic liquid electrolyte that allows transfer of cations has some problems to be solved in that it may cause degradation of safety due to leakage of liquid and an increase in internal resistance due to the side reactions with the electrodes during charge/discharge cycles. To solve the problem of leakage of liquid in such an electrolyte, sodium ion secondary batteries using a solid electrolyte have been developed.

However, it is difficult to apply sodium ion secondary batteries using a solid electrolyte to general compact electronic instruments due to a high driving temperature ranging from 100° C. to 200° C. In addition, since it is further required to add an ion conductive material to supplement a drop in ion conductivity, the number of processing steps is increased and the cost is increased.

Under these circumstances, a gel polymer-based electrolyte has been developed as another type of electrolyte substituting for a liquid electrolyte having a problem of leakage of liquid.

After intensive studies, it has been reported that a gel polymer electrolyte shows a higher uptake amount of organic liquid electrolyte as compared to the conventional separators, and thus provides a battery with high ion conductivity and improved long-term lifespan characteristics. However, the matrix of a gel polymer electrolyte itself has a limitation in that it includes simple polymers. Moreover, sodium cations larger than lithium cations in size undergo a drop in transferability in the matrix, thereby causing a problem of degradation of electrochemical properties.

Therefore, there is a need for developing a gel polymer electrolyte for a secondary battery, such as a sodium ion secondary battery, to provide a battery with high power and high stability.

### REFERENCES

### Patent Documents

(Patent Document 1) Korean Laid-Open Patent No. 2012-0095949
(Patent Document 2) Korean Laid-Open Patent No. 2013-0116022
(Patent Document 3) Korean Laid-Open Patent No. 2010-0052407

### Non-Patent Documents

(Non-Patent Document 1) Y. Q. Yanga et al.; “A sodium ion conducting gel polymer electrolyte”; Solid State Ionics, vol. 269, January 2015, p. 1-7
(Non-Patent Document 2) T. B. Kim et al.; “Ionic Conductivity of Sodium Ion with NaCF3SO3 Salts in Electrolyte for Sodium Batteries”; Materials Science Forum Vols 486-487 (2005) pp 638-641

### SUMMARY

To solve the above-mentioned problems, an embodiment of the present disclosure is directed to providing a gel polymer electrolyte for a secondary battery which improves ion conductivity of sodium cations and provides a secondary battery with improved electrochemical properties.

Another embodiment of the present disclosure is directed to providing a secondary battery including the gel polymer electrolyte according to an embodiment of the present disclosure, and a device including the same.

In one aspect, there is provided a gel polymer electrolyte for a secondary battery, including: (A) a polymer matrix including (a1) a sodium cation-containing polymer and (a2) a fluoropolymer; and (B) an organic liquid electrolyte uptaken in the polymer matrix.

In another aspect, there is provided a secondary battery including the gel polymer electrolyte for a secondary battery according to an embodiment of the present disclosure.

In still another aspect, there is provided a device including the gel polymer electrolyte for a secondary battery according to an embodiment of the present disclosure.

In yet another aspect, there is provided a method for preparing a gel polymer electrolyte for a secondary battery, the method including the steps of: (B) removing (a3) a pore-forming plasticizer from a composite polymer in which (a1) a sodium cation-containing polymer, (a2) a fluoropolymer and (a3) the pore-forming plasticizer are contained homogeneously to obtain a porous polymer matrix; and (C) allowing an organic electrolyte to be uptaken in the pores of the porous polymer matrix.

The gel polymer electrolyte according to an embodiment of the present disclosure includes a sodium cation-containing polymer, and thus improves ion conductivity and provides a secondary battery with improved electrochemical properties.

In addition, the gel polymer electrolyte provides a secondary battery with improved charge/discharge characteristics, prevents leakage of liquid electrolyte when applied to a secondary battery to ensure long-term safety, and can be produced to have a desired shape so that it may be easily applied to batteries having various shapes.

### BRIEF DESCRIPTION OF THE DRAWINGS

FIG. 1 is a flow chart illustrating the process for producing a gel polymer electrolyte according to an embodiment of the present disclosure.

FIG. 2 is a photograph illustrating the polymer matrix forming each of the gel polymer electrolytes obtained according to Examples and Comparative Examples.

FIG. 3 is a scanning electron microscopic (SEM) image of each polymer matrix obtained according to Examples.

FIG. 4 is a graph illustrating a change in discharge capacity depending on charge/discharge cycles to show the results of lifespan characteristics of the sodium ion secondary batteries including each of the gel polymer electrolytes obtained according to Examples and Comparative Examples.

FIG. 5 is a graph illustrating a change in discharge capacity depending on charge/discharge cycles, while current density is increased, in the sodium ion secondary batteries including each of the gel polymer electrolytes obtained according to Examples and Comparative Examples.

### DETAILED DESCRIPTION OF EMBODIMENTS

The advantages, features and aspects of the present disclosure will become apparent from the following description of the embodiments with reference to the accompanying drawings.

In one aspect, there is provided a gel polymer electrolyte for a secondary battery, including: (A) a polymer matrix including (a1) a sodium cation-containing polymer and (a2) a fluoropolymer; and (B) an organic liquid electrolyte uptaken in the polymer matrix.

According to an embodiment, (a1), the sodium cation-containing polymer may include any one of various polymers from which sodium cation can be dissociated in a solvent, such as poly(sodium 4-styrenesulfonate).

However, the use of poly(sodium 4-styrenesulfonate) provides a secondary battery in which sodium cations are transferred, particularly a sodium secondary battery, with an advantageous effect in that poly(sodium 4-styrenesulfonate) has a function as polysalt wherein only cations are dissociated due to the strong binding between SO₃⁻ anion and styrene. This is not the case when other kinds of polymer, even other types of sodium cation-containing polymer is used.

According to another embodiment, (a2), the fluoropolymer may include, but is not limited to: poly(vinylidene fluoride-co-hexafluoropropylene) (PVdF-co-HFP), poly(vinylidene fluoride) (PVdF), polytetrafluoroethylene (PTFE), fluorinated ethylene propylene (FEP), perfluoroalkoxyalkane (PFA) or a mixture thereof.

However, it is required to use a fluoropolymer that is not dissolved in the organic electrolyte uptaken in the polymer matrix.

According to still another embodiment of the gel polymer electrolyte for a secondary battery, (a1), the sodium cation-containing polymer, and (a2), the fluoropolymer are present in the polymer matrix in an amount of 1-60 wt % and 40-99 wt %, respectively, based on the total weight of the polymer matrix.

When (a1) and (a2) are not present within the above-defined ranges, ion conductivity of sodium ions may be decreased significantly, resulting in significant degradation of the overall quality of a secondary battery. Thus, it is preferred to use the ingredients within the above-defined weight ratios.

According to still another embodiment of the gel polymer electrolyte for a secondary battery, the polymer matrix is porous.

Particularly, the polymer matrix may be used in the form of a membrane. Thus, the polymer matrix may be a porous polymer membrane used according to the following examples.

According to still another embodiment of the gel polymer electrolyte for a secondary battery, the polymer matrix may be obtained by removing (a3) a pore-forming plasticizer from a composite polymer in which (a1) a sodium cation-containing polymer, (a2) a fluoropolymer and (a3) the pore-forming plasticizer are contained homogeneously.

According to still another embodiment, (a3), the pore-forming plasticizer may include, but is not limited to: dibutyl phthalate, dimethyl phthalate, dioctyl phthalate or a mixture thereof.

The gel polymer electrolyte may be provided in the form of a porous polymer membrane and may have a thickness of 20-60 μm so that it is suitable for application to an electrolyte for a secondary battery, or a thickness of 30-40 μm depending on particular use.

According to still another embodiment of the gel polymer electrolyte for a secondary battery, (B), the organic liquid electrolyte may include an organic solvent for use in preparing an organic liquid electrolyte, and a sodium salt.

According to yet another embodiment, the organic solvent for use in preparing an organic liquid electrolyte may include, but is not limited to: propylene carbonate, ethylene carbonate, dimethyl carbonate, diethyl carbonate, fluoroethylene carbonate or a mixture thereof. In addition, the sodium salt may include, but is not limited to: NaPF₆, NaClO₄, NaBF₄, NaCF₃SO₃ or a mixture thereof.

In another aspect, there is provided a secondary battery including the gel polymer electrolyte for a secondary battery according to an embodiment of the present disclosure. For example, the secondary battery may be a sodium ion secondary battery.

In still another aspect, there is provided a device including the gel polymer electrolyte for a secondary battery according to an embodiment of the present disclosure.

As used herein, the term ‘device’ includes a portable electronic instrument, transport unit, power system, or the like, but is not limited thereto. In addition, particular examples of the portable electronic instrument include a cellular phone, notebook computer, digital camera, or the like, but are not limited thereto. Particular examples of the transport unit include an electric car, hybrid electric car, plug-in hybrid electric car, or the like, but are not limited thereto. Further, particular examples of the power system include a power storage system, or the like, but are not limited thereto.

In yet another aspect, there is provided a method for preparing a gel polymer electrolyte for a secondary battery, the method including the steps of: (B) removing (a3) a pore-forming plasticizer from a composite polymer in which (a1) a sodium cation-containing polymer, (a2) a fluoropolymer and (a3) the pore-forming plasticizer are contained homogeneously to obtain a porous polymer matrix; and (C) allowing an organic electrolyte to be uptaken in the pores of the porous polymer matrix.

Particularly, the organic liquid electrolyte may be uptaken in the pores of the porous polymer matrix, for example, by dipping the porous polymer matrix in the organic liquid electrolyte for a sufficient time.

According to an embodiment, the method for preparing a gel polymer electrolyte for a secondary battery may further include step (A) dissolving (a1) the sodium cation-containing polymer, (a2) the fluoropolymer and (a3) the pore-forming plasticizer into an organic solvent for use in preparing a composite polymer, followed by drying, to obtain the composite polymer.

According to another embodiment, step (A) may be carried out by dissolving 10-80 parts by weight of a solid mixture of (a1) the sodium cation-containing polymer with (a2) the fluoropolymer, and 5-80 parts by weight of (a3) the pore-forming plasticizer into an organic solvent for use in preparing a composite polymer, based on 100 parts by weight of the organic solvent, followed by drying.

Preferably, the solid mixture may include 1-60 wt % of (a1) the sodium cation-containing polymer and 40-99 wt % of (a2) the fluoropolymer.

According to still another embodiment of the method for preparing a gel polymer electrolyte for a secondary battery, step (B) may be carried out by dipping the composite polymer into an organic solvent for use in dissolving the pore-forming plasticizer.

Such a pore-forming plasticizer may be removed, for example, by dipping the composite polymer into an adequate solvent so that the pore-forming plasticizer may be dissolved out.

According to still another embodiment, (a1), the sodium cation-containing polymer may be poly(sodium 4-styrenesulfonate).

According to still another embodiment, (a2), the fluoropolymer may include, but is not limited to: poly(vinylidene fluoride-co-hexafluoropropylene) (PVdF-co-HFP), poly(vinylidene fluoride) (PVdF), polytetrafluoroethylene (PTFE), fluorinated ethylene propylene (FEP), perfluoroalkoxyalkane (PFA) or a mixture thereof.

According to still another embodiment, (a3), the pore-forming plasticizer may include, but is not limited to: dibutyl phthalate, dimethyl phthalate, dioctyl phthalate or a mixture thereof.

According to still another embodiment, the organic solvent for use in preparing a composite polymer may include, but is not limited to: acetone, benzene, hexane or a mixture thereof. However, it is preferred to use a solvent having high volatility so that the solid mixture may be dissolved or dispersed therein.

According to still another embodiment, the organic solvent for use in dissolving the pore-forming plasticizer may include, but is not limited to: methanol, ethanol or a mixture thereof. However, it is preferred to use an alcohol type organic solvent so that the pore-forming plasticizer may be dissolved therein.

According to still another embodiment, the organic liquid electrolyte may include an organic solvent for use in preparing an organic liquid electrolyte, and a sodium salt.

According to still another embodiment, the organic solvent for use in preparing an organic liquid electrolyte may include, but is not limited to: propylene carbonate, ethylene carbonate, dimethyl carbonate, diethyl carbonate, fluoroethylene carbonate or a mixture thereof.

According to yet another embodiment, the sodium salt may include, but is not limited to: NaPF₆, NaClO₄, NaBF₄, NaCF₃SO₃ or a mixture thereof.

FIG. 1 is a flow chart illustrating the process for producing a gel polymer electrolyte for a secondary battery according to an embodiment of the present disclosure. Referring to FIG. 1, the method for preparing a gel polymer electrolyte for a secondary battery according to an embodiment of the present disclosure may include the steps of: (A) dissolving (a1) a sodium cation-containing polymer, (a2) a fluoropolymer and (a3) a pore-forming plasticizer into an organic solvent for use in preparing a composite polymer, followed by drying, to obtain the composite polymer; (B) removing (a3) the pore-forming plasticizer from the composite polymer in which (a1) the sodium cation-containing polymer, (a2) the fluoropolymer and (a3) the pore-forming plasticizer are contained homogeneously to obtain a porous polymer matrix; and (C) allowing an organic electrolyte to be uptaken in the pores of the porous polymer matrix.

### EXAMPLES

The examples and experiments will now be described. The following examples and experiments are for illustrative purposes only and not intended to limit the scope of this disclosure. In addition, it will be apparent to those skilled in the art that various changes and modifications may be made based on the disclosure of the present disclosure including the following examples.

Materials

In the following examples, acetone is used as an organic solvent, poly(sodium 4-styrenesulfonate) is used as a sodium cation-containing polymer, poly(vinylidene fluoride-co-hexafluoropropylene) is used as a fluoropolymer, dibutyl phthalate is used as a plasticizer, and methanol is used as a volatile solvent.

### Example 1

### (1) Preparation of Mixed Solution

To 100 parts by weight of acetone as a solvent, 15 parts by weight of a solid mixture containing poly(sodium 4-styrenesulfonate) and poly(vinylidene fluoride-co-hexafluoropropylene) (KYNAR2801, Arkema) and 15 parts by weight of dibutyl phthalate are added separately, and then the resultant mixture is subjected to ball milling for 12 hours to obtain a homogeneous mixed solution. The solid mixture includes 10 wt % of poly(sodium 4-styrenesulfonate) and 90 wt % of poly(vinylidene fluoride-co-hexafluoropropylene).

### (2) Production of Polymer Film

Twenty hours after the mixed solution is prepared, the mixed solution is cast onto a glass substrate by using a doctor blade to a thickness of 500 μm and allowed to stand at room temperature for 1 hour to obtain a polymer film.

### (3) Production of Porous Polymer Membrane

The polymer film obtained as described above is dipped in methanol for at least 12 hours to remove dibutyl phthalate. Then, the film is vacuum dried at 70° C. for at least 12 hours to obtain a porous polymer membrane.

### (4) Uptake of Organic Liquid Electrolyte

The porous polymer membrane obtained as described above is impregnated with a liquid electrolyte of 1M NaClO₄ (using a mixed solvent containing propylene carbonate and fluoroethylene carbonate at a volume ratio of 98:2) for a sufficient period of time to obtain a gel polymer electrolyte.

### Example 2

A gel polymer electrolyte is obtained in the same manner as Example 1, except that a solid mixture containing 20 wt % of poly(sodium 4-styrene sulfonate) and 80 wt % of poly(vinylidene fluoride-co-hexafluoropropylene) is used instead of the solid mixture containing 10 wt % of poly(sodium 4-styrene sulfonate) and 90 wt % of poly(vinylidene fluoride-co-hexafluoropropylene).

### Example 3

A gel polymer electrolyte is obtained in the same manner as Example 1, except that a solid mixture containing 30 wt % of poly(sodium 4-styrene sulfonate) and 70 wt % of poly(vinylidene fluoride-co-hexafluoropropylene) is used instead of the solid mixture containing 10 wt % of poly(sodium 4-styrene sulfonate) and 90 wt % of poly(vinylidene fluoride-co-hexafluoropropylene).

### Example 4

A gel polymer electrolyte is obtained in the same manner as Example 1, except that a solid mixture containing 40 wt % of poly(sodium 4-styrene sulfonate) and 60 wt % of poly(vinylidene fluoride-co-hexafluoropropylene) is used instead of the solid mixture containing 10 wt % of poly(sodium 4-styrene sulfonate) and 90 wt % of poly(vinylidene fluoride-co-hexafluoropropylene).

### Comparative Example 1

A commercially available glass fiber separator (Whatman) is prepared.

### Comparative Example 2

A gel polymer electrolyte is obtained in the same manner as Example 1, except that a solid ingredient containing poly(vinylidene fluoride-co-hexafluoropropylene) alone is used instead of the solid mixture containing 10 wt % of poly(sodium 4-styrene sulfonate) and 90 wt % of poly(vinylidene fluoride-co-hexafluoropropylene).

### Test Example 1

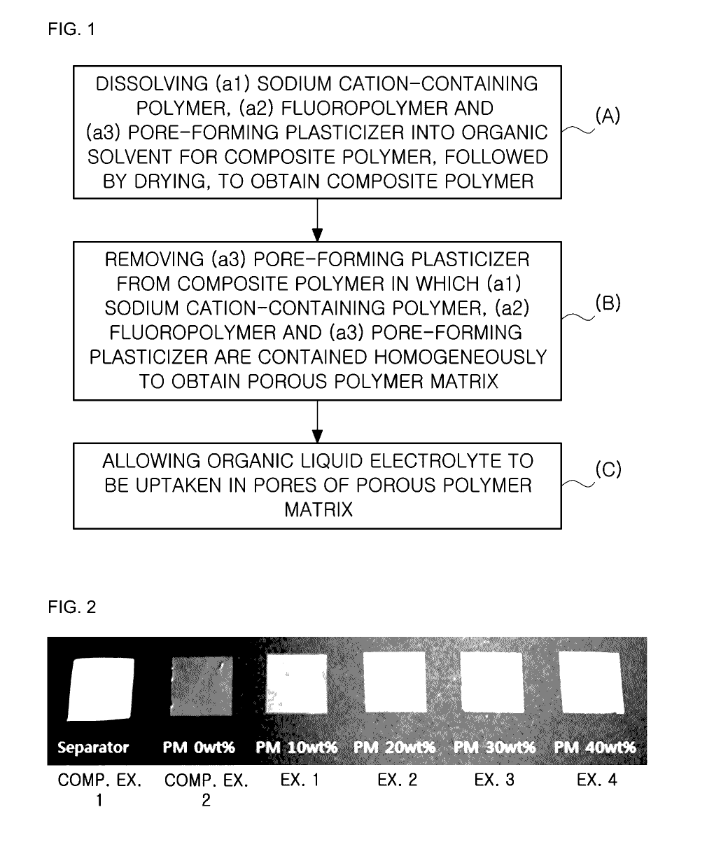

The surfaces of the porous polymer membranes according to Examples 1-4 and Comparative Example 2 and the separator according to Comparative Example 1 are observed by the naked eyes, and the photographs thereof are shown in FIG. 2.

### Test Example 2

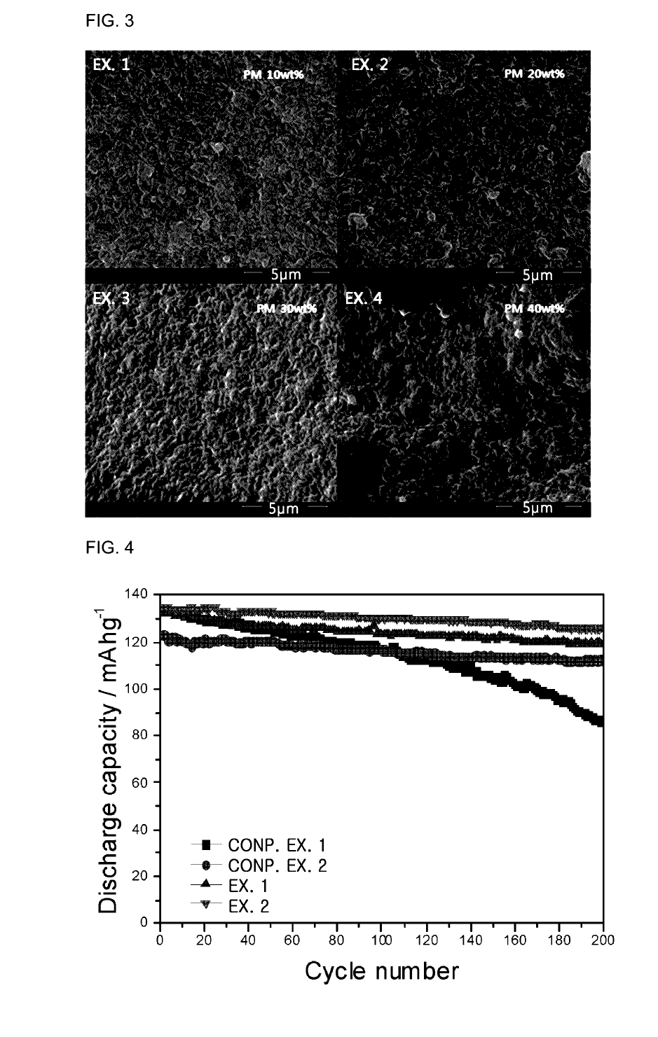

The surfaces of the porous polymer membranes obtained from Examples 1-4 are analyzed by scanning electron microscopy (SEM). After the analysis, it can be seen from FIG. 3 that the surface roughness of a porous polymer membrane and the surface porosity thereof increase from Example 1 to Example 4. It can be expected from the above results that the uptake amount of liquid electrolyte increases accordingly.

In addition, after measurement, it can be seen that each of the porous polymer membranes according to Example 1 to Example 4 has a thickness of 30-40 μm.

### Test Example 3

As described above, gel polymer electrolytes are obtained by allowing an organic liquid electrolyte to be uptaken in a porous polymer membrane according to Examples 1-4 and Comparative Example 2. Each of the gel polymer electrolytes is evaluated in terms of uptake amount of organic liquid electrolyte and ion conductivity, and the results are shown in the following Table 1.

(1) Determination of Uptake Amount of Organic Liquid Electrolyte

When each of the polymer membranes according to Examples 1-4 and Comparative Example 2 is dipped in an organic liquid electrolyte so that the organic liquid electrolyte may be uptaken in each polymer membrane, weight measurement is carried out before and after the uptake of organic liquid electrolyte. Then, each weight after the uptake is expressed by the percentage based on each weight before the uptake to obtain the uptake amount of organic liquid electrolyte.

(2) Determination of Ion Conductivity

The ion conductivity of each gel polymer electrolyte having a liquid electrolyte uptaken therein is determined by using CHI Impedance Analyzer.

TABLE 1

| | Amount of sodium- | Uptake amount | |
|---|---|---|---|
| | containing ionic | of liquid | Ion conductivity |
| | compound | electrolyte | (S/cm) |
| Comp. Ex. 2 | 0 wt % | 130.5% | 3.3 × 10⁻⁴ |
| Ex. 1 | 10 wt % | 172.6% | 7.31 × 10⁻⁴ |
| Ex. 2 | 20 wt % | 188.9% | 1.06 × 10⁻³ |
| Ex. 3 | 30 wt % | 192.3% | 8.12 × 10⁻⁴ |
| Ex. 4 | 40 wt % | 194.3% | 7.97 × 10⁻⁴ |

As shown in Table 1, the gel polymer electrolyte to which no sodium cation-containing polymer is added according to Comparative Example 2 shows little uptake of organic liquid electrolyte. Thus, it is expected that the gel polymer electrolyte provides a battery with poor long-term lifespan characteristics.

On the contrary, each of the gel polymer electrolytes according to Examples 1-4 shows an uptake amount of organic liquid electrolyte increased relatively as compared to the gel polymer electrolyte according to Comparative Example 2, resulting in an increase in ion conductivity.

### Examples 5 and 6

Sodium metal and sodium oxide (NaFe_{0.5}Co_{0.5}O₂) are used as an anode and cathode, respectively, and each of the gel polymer electrolytes obtained from Examples 1 and 2 is used to provide a sodium ion secondary battery. The cathode and anode are prepared in a dry room, and the sodium ion secondary battery is manufactured in a glove box under argon atmosphere.

### Comparative Example 3 and 4

Sodium ion batteries are manufactured in the same manner as Example 5, except that each of the glass fiber according to Comparative Example 1 and the gel polymer electrolyte according to Comparative Example 2 is used instead of the gel polymer electrolyte according to Example 1.

### Test Example 4

To evaluate the lifespan characteristics of each of the sodium ion secondary batteries according to Examples 5 and 6 and Comparative Examples 3 and 4, each sodium ion secondary battery is subjected to charge/discharge cycles 200 times repeatedly at room temperature under a current density of 1.0 C within a voltage ranging from 2.5V to 4.0V.

FIG. 4 is a graph illustrating a change in discharge capacity depending on charge/discharge cycles in each of the sodium ion secondary batteries according to Examples 5 and 6 and Comparative Examples 3 and 4.

As shown in FIG. 4, while the sodium ion secondary battery according to Comparative Example 3 has high porosity to facilitate transfer of sodium cations and thus shows high initial discharge capacity, but undergoes a rapid drop in discharge capacity after charge/discharge cycles are repeated, resulting in poor lifespan characteristics.

In addition, while the sodium ion secondary battery according to Comparative Example 4 shows good lifespan characteristics, it shows poor initial discharge capacity.

On the contrary, each of the sodium ion secondary batteries according to Examples 3 and 4 shows not only high initial discharge capacity but also significantly improved lifespan characteristics.

### Test Example 5

To evaluate the high-rate characteristics of each of the sodium ion secondary batteries according to Examples 5 and 6 and Comparative Examples 3 and 4, each battery is subjected to charge/discharge cycles five times while the rate is varied from a low rate to a high rate. Herein, while the current density (CDc) during charge is set to 0.05 C and the current density (CDd) during discharge is varied to 0.05 C, 0.1 C, 0.2 C, 0.5 C, 1 C, 2 C, 5 C, 10 C and 0.05 C, each battery is subjected to charge/discharge cycles five times for each value of current density during discharge.

Such a test is intended to determine the characteristics of each battery under rapid charge/discharge cycles and evaluates the characteristics by applying a high current sequentially, unlike a test for evaluating lifespan characteristics by applying a constant current density.

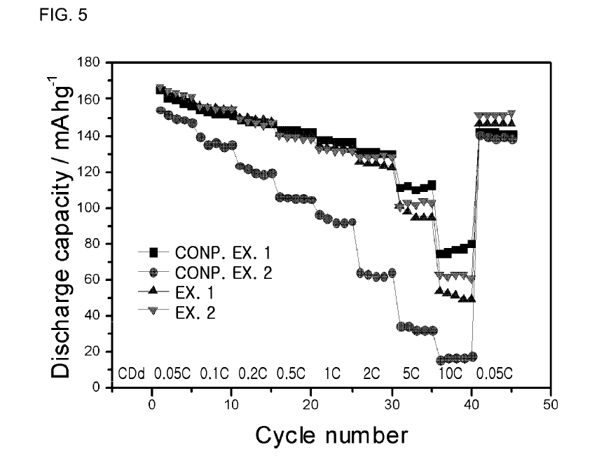

FIG. 5 is a graph illustrating a change in discharge capacity depending on charge/discharge cycles while current density is increased, when each of the gel polymer electrolytes obtained according to Examples and Comparative Examples is applied to a sodium ion secondary battery.

As shown in FIG. 5, the sodium ion secondary battery according to Comparative Example 3 ensures high power characteristics by virtue of high porosity. However, the sodium ion secondary battery according to Comparative Example 4 shows relative poor high power characteristics as compared to Examples, even though it is also a gel polymer electrolyte system similar to Examples.

On the contrary, it can be seen that each of the sodium ion secondary batteries according to Examples 3 and 4 shows excellent high-rate characteristics.

As can be seen from the foregoing, the sodium ion secondary battery according to the present disclosure has high initial discharge capacity and excellent lifespan and high-rate characteristics, and thus can be used as an electrolyte for a next-generation sodium ion secondary battery requiring long-term lifespan safety and flexibility.

While the exemplary embodiments have been shown and described, it will be understood by those skilled in the art that various changes in form and details may be made thereto without departing from the spirit and scope of the present disclosure as defined by the appended claims.

Therefore, it is intended that the scope of the present disclosure not be limited to the above-described particular exemplary embodiments and be defined by the appended claims. In addition, the present disclosure will include all changes and modifications falling within the technical spirit and scope of the appended claims and equivalents thereof.

What is claimed is:

1. A gel polymer electrolyte for a secondary battery, comprising: (A) a polymer matrix comprising (a1) a sodium cation-containing polymer and (a2) a fluoropolymer; and (B) an organic liquid electrolyte uptaken in the polymer matrix.

2. The gel polymer electrolyte for a secondary battery according to claim 1, wherein (a1), the sodium cation-containing polymer is poly(sodium 4-styrenesulfonate).

3. The gel polymer electrolyte for a secondary battery according to claim 1, wherein (a2), the fluoropolymer is selected from poly(vinylidene fluoride-co-hexafluoropropylene) (PVdF-co-HFP), poly(vinylidene fluoride) (PVdF), polytetrafluoroethylene (PTFE), fluorinated ethylene propylene (FEP), perfluoroalkoxyalkane (PFA), and a mixture thereof.

4. The gel polymer electrolyte for a secondary battery according to claim 1, wherein (a1), the sodium cation-containing polymer, and (a2), the fluoropolymer are present in the polymer matrix in an amount of 1-60 wt % and 40-99 wt %, respectively, based on the total weight of the polymer matrix.

5. The gel polymer electrolyte for a secondary battery according to claim 1, wherein the polymer matrix is porous.

6. The gel polymer electrolyte for a secondary battery according to claim 1, wherein the polymer matrix is obtained by removing (a3) a pore-forming plasticizer from a composite polymer in which (a1) a sodium cation-containing polymer, (a2) a fluoropolymer and (a3) the pore-forming plasticizer are contained homogeneously.

7. The gel polymer electrolyte for a secondary battery according to claim 6, wherein (a3), the pore-forming plasticizer is selected from dibutyl phthalate, dimethyl phthalate, dioctyl phthalate and a mixture thereof.

8. The gel polymer electrolyte for a secondary battery according to claim 1, wherein (B), the organic liquid electrolyte comprises an organic solvent for use in preparing an organic liquid electrolyte, and a sodium salt.

9. The gel polymer electrolyte for a secondary battery according to claim 8, wherein the organic solvent for use in preparing an organic liquid electrolyte is selected from propylene carbonate, ethylene carbonate, dimethyl carbonate, diethyl carbonate, fluoroethylene carbonate, and a mixture thereof; and
the sodium salt is selected from NaPF₆, NaClO₄, NaBF₄, NaCF₃SO₃ and a mixture thereof.

10. A secondary battery comprising the gel polymer electrolyte for a secondary battery as defined in claim 1.

11. A device comprising the gel polymer electrolyte for a secondary battery as defined in claim 1, wherein the device is any one selected from a portable electronic instrument, transport unit and a power system.
